(19) United States
(12) Patent Application Publication
(10) Pub. No.: US 2019/0057579 A1
(43) Pub. Date: Feb. 21, 2019

(54) CARD-BASED RANDOM NUMBER GENERATOR

(71) Applicant: Eruch Arthur Kimball, North Hollywood, CA (US)

(72) Inventor: Eruch Arthur Kimball, North Hollywood, CA (US)

(21) Appl. No.: 15/677,266

(22) Filed: Aug. 15, 2017

(51) Int. Cl. G07F 17/32; A63F 1/00

(52) U.S. Cl. CPC G07F 17/3288; A63F 2001/008; G07F 17/3293; A63F 1/00

(57) ABSTRACT

A balanced deck includes a first set of value cards and a second set of draw cards. The first set includes multiple subsets of value cards, each subset of value cards defined by a specific value out of multiple values. The second set of draw cards includes multiple draw cards, the second set including multiple subsets of draw cards, each subset of draw cards defined by respective instruction to draw a specific number of additional cards that is different from the respective instruction of each other subset of draw cards. The first set of cards and the second set of cards are shuffled together to form the balanced deck. In use, a player can draw one or more initial cards from the deck, draw one or more additional cards from the deck based on an instruction on a draw card, and determine a score by adding one or more values associated with any drawn value cards from among the initial cards and additional cards, and/or by grouping value cards into pairs, sets of three or more, or a sequential numerical set of value cards.

### BACKGROUND

Many games are based on randomness, e.g. the generation of random numbers via dice or the drawing of cards from a shuffled deck. Certain forms of random number generation are well understood, e.g. in dice gaming, where players may roll various combinations of dice; in poker, where players draw cards from a deck having a known number of differently valued cards; and in many popular role-playing games, where players may roll dice to determine character traits or the rate of success of certain actions (e.g., rolling a 20-sided die). While dice rolling is a popular tool for quickly generating randomness for games, it suffers several drawbacks. For example, the action of dice rolling is repetitive and percussive; the range of outcomes from rolling dice is well-understood and divorced from exercises of skill or memory. Therefore, a need remains for various new, challenging, and entertaining ways of generating randomness for games.

### BRIEF DESCRIPTION OF THE DRAWINGS

Various embodiments in accordance with the present disclosure will be described with reference to the drawings, in which:

FIG. 1 is a top schematic view of an example of a deck for generating pseudo-random numbers, in accordance with embodiments;

FIG. 2 is a top schematic view showing an example of a balanced deck for generating pseudo-random numbers, in accordance with embodiments; and

FIG. 3 is a schematic view illustrating two exemplary draws from a balanced deck, such as the deck of FIG. 2, for generating pseudo-random numbers, in accordance with embodiments;

FIG. 4 illustrates a process for generating a pseudo-random number from a balanced deck and scoring, in accordance with embodiments; and

FIG. 5 illustrates a computing environment in which disclosed processes may be implemented, in accordance with embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

According to some embodiments of the present disclosure, a balanced deck is disclosed which can be used to generate pseudo-random numbers across a potentially wide range of values. The balanced deck includes a set of value cards (i.e., numerically valued cards, or cards having some other suitable, sequential ordering of value); and a set of draw cards that include instructions for a user to draw some number of cards. The number of value cards in a balanced deck can vary according to the specific use of the deck, the range of values desired, and the probability distribution desired for a specific game.

According to some embodiments, the value cards can range sequentially from 1-6, from 1-8, from 1-20, from 2-12, or from any suitable starting number N₀-N. The specific number of each value card in the set of value cards can also vary, according to the desired probability spread, e.g. a flat spread where the same number of each card is present in a deck (i.e. the same number of each of values 1-6, ideal for approximating one D6 die roll); or a biased spread, where some value cards are more numerous than others (i.e., a deck with values from 2-12, with a distribution curve for approximating a roll of two dice). According to some embodiments, the distribution may be varied by providing for a specific total value (i.e., by summing the values of the cards), but adjusting the specific numbers of each card in the balanced deck to promote different probability distributions.

The draw cards, as well, can vary in quantity and value. For example, the draw cards can include multiple types of draw cards, which vary in terms of the number of cards that each draw card instructs a user to draw. For example, according to some embodiments, the set of draw cards includes a first subset of “draw one” cards, which instruct a user to draw one additional card; and a second subset of “draw two” cards, which instruct a user to draw two additional cards. According to some other embodiments, the set of draw cards can further include a third subset of “draw three” cards, which instruct a user to draw three cards, and so on to any suitable number of draws. In some embodiments, the set of draw cards can include a flat distribution of draw cards of different values, e.g., a number N_{D1} of “draw one” cards, a second number N_{D2} of “draw two” cards, and a third number N_{D3} of “draw three” cards, where all three numbers N_{DX} are the same. According to some other embodiments, the numbers of draw cards of each type may be different from each other, with the specific number being tuned to alter a probability of drawing each type of draw card.

According to some other embodiments of the present disclosure, a method is disclosed for using a balanced deck to generate a random number for gaming. For example, according to some embodiments, a random number can be generated by shuffling a balanced deck having a distribution of the value cards and draw cards, subsequently drawing additional cards if directed to do so by one or more draw cards, and finally summing the values of all value cards drawn in this way. According to some embodiments, the process of drawing an additional card or cards, if instructed to do so by a draw card, can be repeated for as long as there is an active draw card (i.e., for as long as a user has not yet finished complying with a “draw” instruction). Hypothetically, the process of drawing cards in this way may be repeated until the entire deck has been drawn, depending on the number of draw cards and value cards in the deck. If combined with periodic shuffling of a discard pile back into the deck, the process of drawing cards in this way may be repeated ad infinitum at very low probabilities. According to some embodiments, the process of drawing additional cards may proceed down to a predetermined number of “layers,” i.e., a predetermined number of instances of drawing and complying with all active draw cards. According to some other embodiments, the process of drawing additional cards may be halted if a certain maximum value is exceeded (i.e., a cap on the roll), or after a certain number of cards have been drawn.

According to some other embodiments of the present disclosure, a method of assembling a balanced deck is disclosed, in which a user selects a first set of a predetermined number and distribution of value cards, a second set of a predetermined number and distribution of draw cards, and shuffles the first and second sets together to form a balanced deck which can generate pseudo-random numbers. The specific distributions of value cards in the first set can vary in order to tune the probability of drawing a specific value from any one draw. For example, according to some embodiments, a first set may have a flat distribution that approximates a single die roll; a curved distribution that approximates a roll of multiple dice (e.g., 2, 3, or more dice); or a special-purpose distribution with varying numbers of each value card in order to produce probability distributions that are impossible with dice. For example, according to some embodiments, the first set can have a “high end” distribution, with a greater number of cards at the highest included value, such that a probability of very high rolls is increased; a “safe” distribution, with a majority of value cards being at or near a median value; or a “high risk” distribution, with few cards near the median value, and most either being high or low value. According to some embodiments, the distribution of value cards may be limited by imposing a rule on the value of the cards in a deck, e.g., a target value corresponding to the sum of the values of all included value cards.

Methods of assembling a balanced deck may also include adjusting the distribution and number of draw cards, e.g., by increasing or decreasing the relative number of “draw one” cards, “draw two” cards, or other values of draw cards. In some embodiments, the distribution of draw cards may be adjusted to map the possible drawing outcomes more closely to standard gaming conventions. For example, according to some embodiments, the second set of draw cards may have a distribution of “draw one,” “draw two,” and “draw three” cards tuned to interact with a predetermined number and distribution of value cards in order to approximate a roll of a D20 die, or any other suitable die. According to some embodiments, the second set of draw cards can have a flat distribution, in which the second set contains the same number of each respective value of draw card. According to some other embodiments, the second set of draw cards can have a curved distribution, in which a first subset of draw cards (e.g., “draw one” cards,) is fewer in number than a second subset of draw cards (e.g., “draw two” cards), and in which a third subset of draw cards (e.g. “draw three” cards) also has fewer cards than the second subset. A curved distribution may be used to adjust the likelihood of explosive, i.e. unpredictably large “draws” or “rolls,” and the distribution may be adjusted to preferentially increase or decrease the prevalence of large draws.

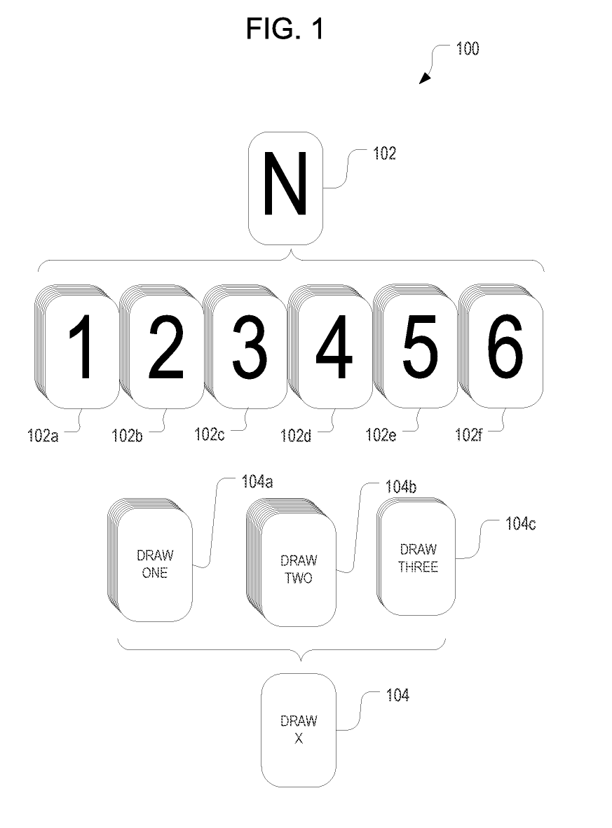

FIG. 1 illustrates an example of contents of a balanced deck 100, in accordance with some embodiments. The balanced deck 100 includes a first set 102 of value cards, shown here as numerical cards having progressing values, e.g. a numerical progression. According to this example, the first set 102 of value cards has six distinct values, in sequential order from 1 to 6 (102a-102f). As discussed above, various alternative embodiments may include more or fewer value cards (e.g., any suitable number of values, or value cards ranging from 1-6, from 1-8, from 1-10, from 1-12, from 1-13, or other suitable ranges). A second set 104 of draw cards includes multiple subsets of draw cards (e.g., 104a-c), each subset providing an indication to a user to draw one or more additional cards. According to this example, the second set 104 of draw cards includes a subset of “draw one” cards 104a that include an instruction to draw one additional card, a subset of “draw two” cards 104b that include an instruction to draw two additional cards, and a third subset of “draw three” cards 104c that include an instruction to draw three additional cards. According to various embodiments, the specific number of subsets of draw cards may vary from 2 subsets to any suitable number of subsets of draw cards. Furthermore, the specific number of cards that each subset of draw cards instructs a user to draw may vary, e.g., from 1-3 cards, from 1-4 cards, from 1-5 cards, or more.

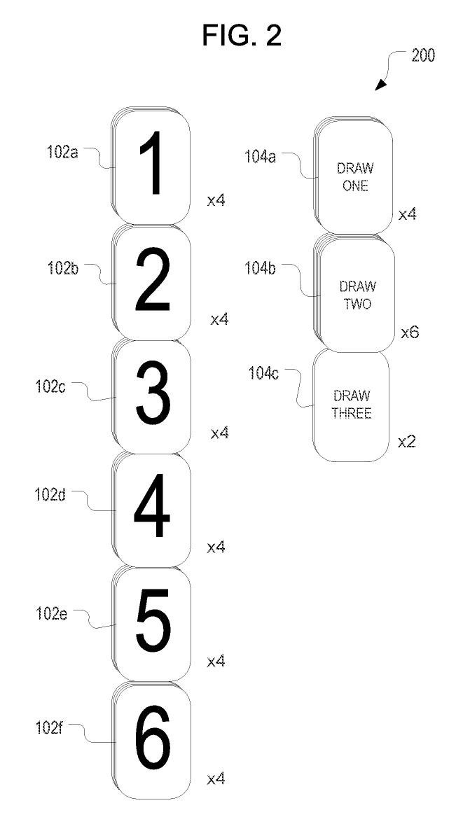

FIG. 2 illustrates an example of a balanced deck 200 having a flat distribution of value cards (102a-f, cumulatively 102) and a curved distribution of draw cards (104a-c, cumulatively 104), in accordance with embodiments. In the exemplary balanced deck 200, value cards 102 with values from 1-6 are included in a flat distribution, meaning that the same number of cards is included for each subset of value cards 102a-f. In this case, four copies of each value card 102a-f are included. The curved distribution of the draw cards 104 includes a first number of “draw one” cards 104a, a second number of “draw two” cards 104b, and a third number of “draw three” cards 104c, where the second number is greater than the first and third numbers. In the specific example deck 200, four “draw one” cards are included, six “draw two” cards, and two “draw three” cards, although other distributions can be used.

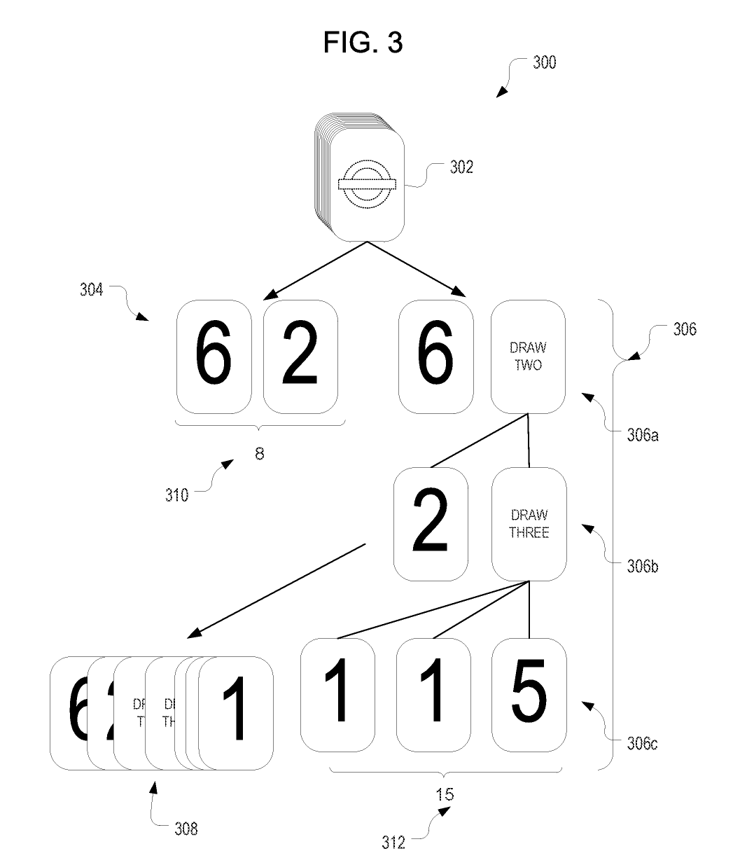

The distributions of the draw cards 104 and of the value cards 102 in the balanced deck 200 interact to create a probability distribution for draws obtained using the balanced deck. The specific distributions of cards may also be expressed in terms of a distribution factor ‘N’. For example, in the balanced deck 200, for N=4, each subset of value cards has 1.0×N cards, and the distribution of draw cards can be described as N “draw one” cards, 1.5×N “draw two” cards, and 0.5×N “draw three” cards. According to some embodiments, a balanced deck may be defined according to such ratios, where N can be any suitable number, and may be increased or decreased to accommodate more or fewer players, or in order to increase or decrease the relative importance of recalling the values of discarded cards. These ratios can be adjusted to change the probability distribution of particular draws from the balanced deck. In some embodiments, the ratios can be tuned to provide for draws mimicking the probability distributions of dice, as in for a role-playing game, however with increased probabilities of certain outcomes and a potentially wider spread of outcomes. Two exemplary draws from such a balanced deck are described below with reference to FIG. 3 to better illustrate the method of producing pseudo-random numbers using the deck.

FIG. 3 illustrates examples of a card drawing process 300 for obtaining draws from a balanced deck, such as the deck 200 of FIG. 2, to generate pseudo-random numbers in accordance with various embodiments of the disclosure. A balanced deck 302 is assembled according to any of the procedures disclosed herein, and a user draws cards from the deck. One draw can include drawing a single card or multiple cards in any suitable, predetermined number. The process 300 illustrates example draws where an initial draw includes drawing two cards. A first, simple case 304 illustrates what occurs if only value cards are drawn during a two-card initial draw. Here, the value cards (valued at 6 and 2) add to a score 310 of 8, which is used as the player's draw score. Note that, by drawing two cards, the range of values obtainable via the draw process begins at 2 and has a curved bias, comparable to rolling a pair of dice. In one embodiment, the distribution of the value cards may be flat, e.g., for value cards numbered 1-6, a flat distribution would contain the same number of each of the value cards, although other distributions may be used. When a discard pile is used without being immediately reshuffled into the deck, the probabilities of drawing cards of each value change according to the discarded cards.

A complex case 306 illustrates what occurs if an initial draw 306a includes a draw card and a value card. Here, because a draw card was drawn, the initial draw 306a is regarded as a first layer of draw steps, and an additional draw step 306b occurs forming a second layer of draw steps. The additional draw step 306b may result in drawing only value cards, only draw cards, or both. As shown here, the additional draw step 306b also results in drawing an additional draw card, which triggers yet another additional draw step 306c, or a third layer of draw steps. Although, in theory, additional draw cards may continue to be drawn until the deck 302 is empty (or ad infinitum, if the deck is replenished), the probability of drawing additional draw cards, and thus of going into additional layers of draw steps, diminishes with each additional draw step, typically resulting in a final draw of only value cards within a few layers. Here, the third layer 306c happens to result in a draw of only value cards, ending the round of draws, and resulting in a final score 312 from the complex case 306 of 15.

According to some embodiments, cards may be placed in a discard pile 308 during play, thus diminishing the likelihood of repetitive plays and providing information to any players. For example, after a complex play 304, the discard pile will include each value card and draw card used during the complex play. Similarly, after the simple play 302, the discard pile will grow only by a set of value cards or low-value draw cards. Thus, after a string of simple plays, or a string of complex plays, the discard pile will contain a subset of the deck 302, such that the remainder of the deck is loaded to produce either simpler, or more complex, plays during future draws. This departure from pure randomness increases the likelihood of a balanced, exciting game including both small and complex plays.

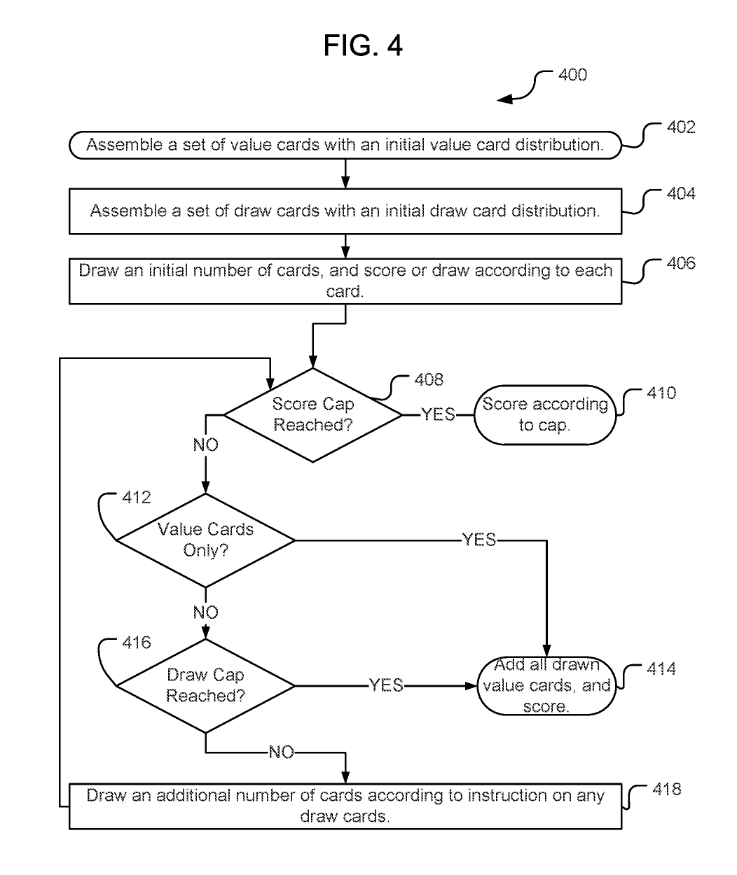

FIG. 4 illustrates a process 400 for generating a pseudo-random number from a balanced deck and scoring, in accordance with embodiments. First, a balanced deck is assembled by assembling a set of value cards with an initial value card distribution (act 402). This distribution may be flat, curved, or uneven according to the specific needs of the player. The balanced deck is completed by assembling, with the value cards, a set of draw cards with an initial draw card distribution (act 404). Again, the draw card distribution may also be flat, curved, or uneven according to the specific needs of the player. Certain distributions, such as the balanced deck 200 described with reference to FIG. 2, may be ideal for approximating a D20 roll, as desired for a roll playing game or comparable. However, any other suitable distributions may be used as discussed above.

Next, an initial number of cards, which can include both value cards and “draw” cards (e.g., one card, two cards, three cards, or more, as needed) are drawn (act 406), and the values on any value cards are added to a running score (act 406). In some embodiments, the draw may end if the running score exceeds a score cap (i.e., for a deck designed to approximate a D20, a score cap may be placed at 20). If the score cap is reached (act 408), then the draw step can end by scoring the draw according to the cap (act 410). If not, or if a score cap is not used, then the draw is scored. If only value cards are drawn (act 412), the values of all drawn value cards are added to produce a final score (act 414). In some embodiments, the draw may be controlled by a predetermined cap on the number of draws or layers. If a draw cap is used, and the number of additional draws matches the draw cap (act 416), then the draw may end and the values of all drawn value cards can be added to produce the final score (act 414), even if some draw cards remain. If a draw cap is not used, or has not been reached, then an additional draw step, or layer, is initiated according to the instruction(s) on any draw cards that were drawn in the previous step (act 418). The scoring procedure repeats until one of the terminal conditions is met, e.g., a score cap, a draw cap, or a draw containing only value cards.

The deck assemblies and drawing procedures described herein are amenable to many specific variations which may be applied to games of chance. Several distinct examples are discussed in some detail below, however, it will be understood that the uses of a balanced deck and the variations on drawing procedures are not limited to only these examples.

### Example 1: Role Playing Games

According to some embodiments, the specific value card and draw card distributions in a balanced deck may be varied to achieve different probability spreads. This variation in probability spreads may be used to tune a deck to match a character class in a role playing game (RPG). For example, a low-level character may be limited to a low total value (i.e., low total sum of all value cards), requiring the use of fewer cards having high values, and more cards having low values. Conversely, a high-level character may be allowed to have a high total value, resulting in a deck stacked with a greater proportion of high-value cards.

According to some embodiments, the probability spread of a balanced deck may be manipulated at a specific total value, i.e. without changing the total value, in order to represent certain characteristics. Such balanced decks may be used to represent player characters or non-player characters according to such characteristics as class, temperament, equipment, or the like. For example, several suitable card distributions are shown below with reference to Table 1 that may be used to define character traits with a total value N_{T} equal to 60.

TABLE 1
Exemplary Value Card Spreads for N_{T} = 60
Balanced and math-neutral

| | | | | |
|---|---|---|---|---|
| 1 | 2 | 3 | 4 | 5 |
| 1 | 2 | 3 | 4 | 5 |
| 1 | 2 | 3 | 4 | 5 |
| 1 | 2 | 3 | 4 | 5 |

High Top - Low consistency but occasional big plays

| | | | | |
|---|---|---|---|---|
| 1 | 2 | 3 | 4 | 6 |
| 1 | 2 | 3 | 4 | 6 |
| 1 | 2 | 2 | 3 | 6 |
| 1 | 2 | 2 | 3 | 6 |

No Ones - High consistency but low top end

| | | | | |
|---|---|---|---|---|
| 2 | 2 | 3 | 4 | 4 |
| 2 | 2 | 3 | 4 | 4 |
| 2 | 2 | 3 | 4 | 4 |
| 2 | 2 | 3 | 4 | 4 |

Very Flat - High consistency, few poor plays

| | | | | |
|---|---|---|---|---|
| 2 | 3 | 3 | 3 | 4 |
| 2 | 3 | 3 | 3 | 4 |
| 2 | 3 | 3 | 3 | 4 |
| 2 | 3 | 3 | 3 | 4 |

Actually Flat - No surprise plays

| | | | | |
|---|---|---|---|---|
| 3 | 3 | 3 | 3 | 3 |
| 3 | 3 | 3 | 3 | 3 |
| 3 | 3 | 3 | 3 | 3 |
| 3 | 3 | 3 | 3 | 3 |

Single Six - Balanced with rare high rolls

| | | | | |
|---|---|---|---|---|
| 1 | 2 | 3 | 4 | 5 |
| 1 | 2 | 3 | 4 | 5 |
| 1 | 2 | 3 | 4 | 5 |
| 1 | 2 | 3 | 3 | 6 |

Double Six - Balanced with rare high rolls

| | | | | |
|---|---|---|---|---|
| 1 | 2 | 3 | 4 | 4 |
| 1 | 2 | 3 | 4 | 5 |
| 1 | 2 | 3 | 4 | 6 |
| 1 | 2 | 3 | 3 | 6 |

“Mr. Frowns” - Poorly balanced

| | | | | |
|---|---|---|---|---|
| 1 | 3 | 3 | 3 | 5 |
| 1 | 3 | 3 | 3 | 5 |
| 1 | 3 | 3 | 3 | 5 |
| 1 | 3 | 3 | 3 | 5 |

Slow Slope - Balanced with rare high and low rolls

| | | | | |
|---|---|---|---|---|
| 1 | 2 | 3 | 4 | 6 |
| 1 | 2 | 3 | 4 | 6 |
| 2 | 2 | 2 | 3 | 5 |
| 2 | 2 | 2 | 3 | 5 |

“Smiley” - Poorly balanced with frequent high and low rolls.

| | | | | |
|---|---|---|---|---|
| 1 | 1 | 2 | 3 | 6 |
| 1 | 1 | 2 | 3 | 6 |
| 1 | 2 | 2 | 6 | 6 |
| 1 | 2 | 2 | 6 | 6 |

One core concept of role playing games (RPG), for which a balanced deck as described herein is ideally suited, is the concept of leveling. In RPG's, a character is generally expected to “level up” by increasing in ability over the course of a game. Using a balanced deck, leveling can be achieved by customizing the contents of the deck according to predefined rules when a new level is achieved. For example, leveling up can entail the addition of higher-value cards to a deck without removing cards. In one example, a low-level deck may have fewer cards than a high-level deck (i.e., 32 or 34 cards for a level 0 or 1 deck; and 36 cards for a deck of level 2 or higher, where the additional cards are high-value cards). In another example, each level can be assigned to a particular total deck value, i.e. total value N_{T}, described above. Thus, a player can standardize a character's deck according to level by assembling the deck according to the prescribed N_{T} of its level; while concomitantly customizing the character according to personal preference, or other criteria, by selecting a particular spread. This degree of standardization creates a framework for group games, while customization allows players to imbue their character deck with characteristics suited to their playstyle or preferred character.

The probability spread of a balanced deck may include even greater variations than those shown with respect to Table 1 by expanding on the total value N_{T} of the deck. For example, Table 1 may represent deck options available for character attributes early in a role playing game, e.g. at level 0 or 1. The total value of a deck, or the value cards available for use by players in building a deck, may change with level. For example, a higher level character may use a deck with a higher N_{T}, or a deck including a number of cards having higher individual values than those of the low level character, or both. Table 2, below, illustrates several examples of character decks for a high level character with an N_{T} of 84 rather than 60, in which some decks include value cards up to 9 rather than up to 6.

TABLE 2
Exemplary Value Card Spreads for N_{T} = 84
Balanced and math-neutral

| | | | | | |
|---|---|---|---|---|---|
| 1 | 2 | 3 | 4 | 5 | 6 |
| 1 | 2 | 3 | 4 | 5 | 6 |
| 1 | 2 | 3 | 4 | 5 | 6 |
| 1 | 2 | 3 | 4 | 5 | 6 |

High Top - Low consistency but occasional big plays

| | | | | | |
|---|---|---|---|---|---|
| 1 | 2 | 3 | 5 | 5 | 6 |
| 1 | 2 | 3 | 5 | 5 | 6 |
| 1 | 2 | 2 | 3 | 6 | 6 |
| 1 | 2 | 2 | 3 | 6 | 6 |

No Ones - High consistency but low top end

| | | | | | |
|---|---|---|---|---|---|
| 2 | 2 | 3 | 4 | 4 | 5 |
| 2 | 2 | 3 | 4 | 4 | 5 |
| 2 | 2 | 3 | 4 | 5 | 6 |
| 2 | 2 | 3 | 4 | 5 | 6 |

Very Flat - High consistency, few poor plays

| | | | | | |
|---|---|---|---|---|---|
| 2 | 3 | 3 | 4 | 4 | 5 |
| 2 | 3 | 3 | 4 | 4 | 5 |
| 2 | 3 | 3 | 4 | 4 | 5 |
| 2 | 3 | 3 | 4 | 4 | 5 |

“Pretty Darn Flat” - No surprise plays

| | | | | | |
|---|---|---|---|---|---|
| 3 | 3 | 3 | 4 | 4 | 4 |
| 3 | 3 | 3 | 4 | 4 | 4 |
| 3 | 3 | 3 | 4 | 4 | 4 |
| 3 | 3 | 3 | 4 | 4 | 4 |

Extra Six - Balanced with rare high rolls

| | | | | | |
|---|---|---|---|---|---|
| 1 | 2 | 3 | 4 | 5 | 6 |
| 1 | 2 | 3 | 4 | 5 | 6 |
| 1 | 2 | 3 | 4 | 5 | 6 |
| 1 | 2 | 3 | 3 | 6 | 6 |

Double Extra Six - Balanced with rare high rolls

| | | | | | |
|---|---|---|---|---|---|
| 1 | 2 | 3 | 4 | 4 | 6 |
| 1 | 2 | 3 | 4 | 5 | 6 |
| 1 | 2 | 3 | 4 | 6 | 6 |
| 1 | 2 | 3 | 3 | 6 | 6 |

“Mr. Frowns” - Poorly balanced

| | | | | | |
|---|---|---|---|---|---|
| 1 | 1 | 3 | 3 | 5 | 7 |
| 1 | 1 | 3 | 3 | 5 | 7 |
| 1 | 2 | 3 | 3 | 6 | 7 |
| 1 | 2 | 3 | 3 | 6 | 7 |

Slow Slope - Balanced with rare high and low rolls

| | | | | | |
|---|---|---|---|---|---|
| 1 | 1 | 3 | 4 | 6 | 6 |
| 1 | 2 | 3 | 4 | 6 | 7 |
| 1 | 2 | 2 | 3 | 5 | 7 |
| 1 | 2 | 2 | 3 | 5 | 7 |

“Smiley” - Poorly balanced with frequent high and low rolls.

| | | | | | |
|---|---|---|---|---|---|
| 0 | 1 | 2 | 3 | 5 | 7 |
| 1 | 1 | 2 | 3 | 5 | 7 |
| 1 | 2 | 2 | 4 | 6 | 8 |
| 1 | 2 | 2 | 4 | 6 | 9 |

The spreads and the total values N_{T} can also be tuned to capture characteristics of an RPG character. For example, a deck can be assembled based on combinations of subsets of the deck, where each subset corresponds to a character trait. In one example, two decks can be used to represent a character: an “actions” deck, which is used to pseudo-randomly generate numbers for character actions like attacks and attempts at physical feats; and a “skills” deck, which is typically used to generate numbers for character responses to events, like evading attacks or performing unique character-based skills (although there may be some overlap between the categories to which each deck applies). In each deck, a subset of the cards are generally “draw” cards; a second subset of the cards are “race traits,” i.e. a distribution of numeric cards based on the RPG character's selected race; and a third subset of cards are “class traits,” i.e. a selection of numeric cards based on the RPG character's selected class.

In use, the actions and skills decks may be used in a manner similar to a classical RPG dice roll. First, depending on context, a player may or may not shuffle their skills and/or action decks. For example, if a battle is ongoing, cards may be left out if discarded, to represent fatigue. The player who is called upon to draw, either to represent the power of an action or attack, will draw cards (i.e. one card, up to two cards, or more) from whichever deck is being checked against (e.g., actions deck for attacks vs. skills deck for evasion). The player can then play any number of cards from his or her hand and add the values of all the value cards played, or in some cases, the values of all value cards played and all value cards drawn due to playing “draw” cards. In some cases, the success or failure of an action may be determined by whether the total score, or summed value of the value cards, meets or exceeds a particular value or threshold. This threshold may be, e.g., a value associated with a game-master (GM) created opponent, another player, an in-game challenge (e.g., lock picking, searching, sensing), or the like. At the end of a turn or action, each player may be required to discard down to a predetermined number of cards, often to one or two cards, which can be kept in reserve.

Depending on context, the reasons for playing or reserving cards in one's hand can vary, and will be driven by the specific combat mechanics at work. For example, a player may need to “meet or beat” a value associated with an attack or event; or play less than a given value; or may wish to retain a high-value card in hand for use in future plays. Because of the construction of a balanced deck, each play can work similarly to rolling a twenty-sided die, but with much more potential for manipulation due to the draw cards and the spread.

### Example 2: Betting Games

According to some embodiments, a balanced deck may also be used to play a poker-like game of probability and bluffing, e.g. using the deck 100 described in FIG. 1, or the deck 200 described in FIG. 2. According to one embodiment, a balanced deck betting game may be played by assembling a 72-card deck (e.g. a deck containing 72 cards including 8 copies of each of value cards 1-6, eight copies of “draw one” cards, twelve copies of “draw two” cards, and four copies of “draw three” cards). In alternative embodiments, a different assembly of a balanced deck may be used.

The betting game can proceed by dealing one card to each player face down, and one card to each player face up. Starting with the first player dealt, each player looks at their hand, and checks, bets, raises, calls, or folds depending on the value of any value cards in their hand, the power of any draw cards (e.g., “draw two” or “draw three” cards), and decisions by other players. In turn, each player may play as many value cards as they want, and as many draw cards as they want, taking additional cards face down based on the power of any draw cards played. A second round of betting can then occur. Additional rounds of play can occur as long as a player retains at least one card in hand to play in a subsequent round. Scoring may be conducted by total value of all played value cards, or according to a set hierarchy similar to poker. For example, one possible set hierarchy is described below with reference to Table 3, but it will be understood that additional sets are possible with an expanded deck.

TABLE 3
Set Hierarchy for Balanced Deck Betting Game

Number (lowest)
Pair
Three of a Kind
Two Pair
Full House
Four of a Kind
Two Sets of Three
Straight (1-5 or 2-6)
Five of a Kind
Straight (1-6)
Two Sets of Four
Three Sets of Three
Six of a Kind (high)

Various alternative betting games are also possible using a balanced deck with modifications to the number of initially drawn cards, to the number of cards kept from the initial set, to the betting process, and other alterations to the general game rules.

### Computer Applicability

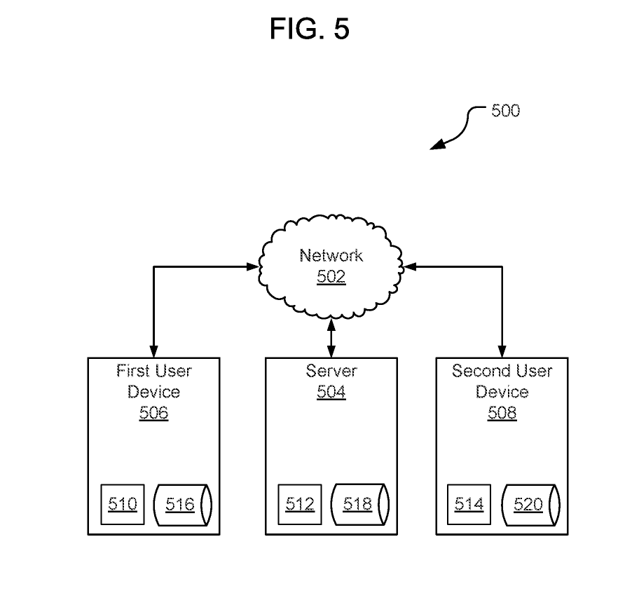

Some or all of the process 400 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. For example, one suitable computing environment 500 for implementing the above processes is described with reference to FIG. 5.

According to some embodiments, any suitable balanced deck such as the deck 100 shown in FIG. 1 or the balanced deck 200 shown in FIG. 2 can be implemented virtually by storing the card values and generating a random draw from a selection of card values. FIG. 5 illustrates one suitable environment for implementing a virtual balanced deck, in which a first user device 506, i.e. a computing device such as a desktop or laptop computer, smartphone, tablet, or comparable device is connected with a second user device 508 via a network 502. Each user device 506, 508 can include processing 510, 514 and memory 516, 520 for storing local data and displaying the data to the users via the respective user devices. According to some embodiments, an instance of a virtual deck can be maintained on one, or on both, of the user devices 506, 508, e.g. in memory, and one or the other of the user devices can perform virtual operations representative of draw steps, e.g. in accordance with process 400 described above with reference to FIG. 4.

In some embodiments, a server 504 may instead be used to maintain the virtual operations, including storing the deck and the deck status (e.g., cards in discard, cards remaining, and the specific distribution of cards in a balanced deck), via server processing 512 and memory 518. Each user device 506, 508 may connect with the server 504 by way of the network 502 in order to communicate player decisions to the server or to the other user.

Virtual tasks that can be performed using an electronic user device can include, e.g., generating a pseudo-random number based on a balanced deck (simple case), in which case the draw steps as described above may be operated from a user device according to a predetermined balanced deck. In some embodiments, a user may be prompted to input parameters for a balanced deck, in which case the user has the option to adjust the balanced deck in the virtual environment. In some embodiments, a user may use the system 500 to engage with other users in order to view the results of any one player's draw across each user device.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A balanced deck, comprising:
a first set of cards comprising value cards, the first set including multiple subsets of value cards, each subset of value cards defined by a specific value of a plurality of values; and
a second set of cards comprising draw cards, the second set including multiple subsets of draw cards, each subset of draw cards defined by respective instruction to draw a specific number of additional cards that is different from the respective instruction of each other subset of draw cards; wherein
the first set of cards and the second set of cards are shuffled together.

2. The balanced deck of claim 1, wherein
the first set of cards comprises six subsets of value cards, the six subsets of value cards defining values from one to six; and
the second set of cards comprises three subsets of draw cards, the three subsets of draw cards defining instructions to draw one card, to draw two cards, and to draw three cards, respectively.

3. The balanced deck of claim 2, wherein
each subset of the six subsets of value cards contains four value cards;
the first subset of draw cards contains four draw cards;
the second subset of draw cards contains six draw cards; and
the third subset of draw cards contains two draw cards.

4. The balanced deck of claim 1, wherein
the first set of cards has a flat distribution, wherein each subset of the value cards has the same number of cards as each other subset of value cards.

5. The balanced deck of claim 1, wherein
the first set of cards has a curved distribution, wherein a second subset of the first set of cards contains a greater number of cards than a first subset of the first set of cards, and wherein a third subset of the first set of cards contains fewer cards than the second subset of cards, wherein the first, second, and third subsets of cards have values in rising order.

6. The balanced deck of claim 1, wherein
the first set of cards has an uneven distribution, wherein a second subset of the first set of cards contains fewer cards than a first subset of the first set of cards, and wherein a third subset of the first set of cards contains a greater number of cards than the second subset of cards, wherein the first, second, and third subsets of cards have values in rising order.

7. The balanced deck of claim 1, wherein
the second set of cards has a curved distribution, wherein a first subset of draw cards contains a first number of draw cards, a second subset of draw cards contains a second number of draw cards, and a third subset of draw cards contains a third number of draw cards, the second number being larger than the first number or the third number, wherein the first, second, and third subsets of cards have values in rising order.

8. The balanced deck of claim 1, wherein
each card of the first and second sets of cards has a back and a front;
the respective values and instructions of the first and second sets of cards are indicated on the front of each card; and
a common image is presented on the back of each card, such that the first and second sets of cards are indistinguishable from one another from the back.

9. A method of generating random numbers via a balanced deck, the method comprising:
with a deck comprising:
a first set of cards comprising value cards, the first set including multiple subsets of value cards, each subset of value cards defined by a specific value of a plurality of values; and
a second set of cards comprising draw cards, the second set including multiple subsets of draw cards, each subset of draw cards defined by respective instruction to draw a specific number of additional cards that is different from the respective instruction of each other subset of draw cards; wherein the first set of cards and the second set of cards are shuffled together;
drawing one or more initial cards from the deck;
in response to drawing a draw card, drawing one or more additional cards from the deck based on an instruction on the draw card; and
determining a score by adding one or more values associated with the one or more value cards from among the one or more initial cards and one or more additional cards.

10. The method of claim 9, further comprising:
whenever a draw card is drawn among the additional cards, iteratively repeat the draw additional cards step for each draw card.

11. The method of claim 9, further comprising:
whenever a draw card is drawn among the additional cards, draw a new card until a value card is drawn.

12. The method of claim 9, further comprising:
whenever a draw card is drawn among the additional cards, determine whether the score has exceeded a predetermined value; and
if the score has not exceeded the predetermined value, iteratively repeat the draw additional cards step for each draw card.

13. The method of claim 9, further comprising:
shuffling discarded cards into the deck prior to the drawing of one or more initial cards.

14. A method of assembling a balanced deck, comprising:
assembling a first set of cards comprising value cards, the first set including multiple subsets of value cards, each subset of value cards defined by a specific value of a plurality of values;
assembling a second set of cards comprising draw cards, the second set including multiple subsets of draw cards, each subset of draw cards defined by respective instruction to draw a specific number of additional cards that is different from the respective instruction of each other subset of draw cards; and
assembling the first set of cards and the second set of cards together.

15. The method of claim 14, wherein:
assembling the first set of cards comprises assembling six subsets of value cards, the six subsets of value cards defining values from one to six, and each subset containing a number N multiple of four cards; and
the second set of cards comprises three subsets of draw cards, the three subsets of draw cards defining instructions to draw one card, draw two cards, and draw three cards, respectively, the first subset containing N×four cards, the second subset containing N×six cards, and the third subset containing N×two cards.

16. The method of claim 14, wherein:
assembling the first set of cards comprises assembling the subsets of value cards in a flat distribution, wherein each subset of the value cards has the same number of cards as each other subset of value cards.

17. The method of claim 14, wherein:
assembling the first set of cards comprises assembling the subsets of value cards in a curved distribution, wherein a second subset of the first set of cards contains a greater number of cards than a first subset of the first set of cards, and wherein a third subset of the first set of cards contains fewer cards than the second subset of cards, wherein the first, second, and third subsets of cards have values in rising order.

18. The method of claim 14, wherein:
assembling the first set of cards comprises assembling the subsets of value cards in an uneven distribution, wherein a second subset of the first set of cards contains fewer cards than a first subset of the first set of cards, and wherein a third subset of the first set of cards contains a greater number of cards than the second subset of cards, wherein the first, second, and third subsets of cards have values in rising order.

19. The method of claim 14, wherein:
the values associated with each value card of the first set of cards sum to a predetermined total value.

20. The method of claim 19, wherein the predetermined total value is a first predetermined total value; and further comprising:
altering a distribution of the first set of cards according to the values of the cards such that the values of the first set of cards sum to a second predetermined total value that is greater than the first predetermined total value.
